(19) United States
(12) Patent Application Publication
(10) Pub. No.: US 2006/0094375 A1
(43) Pub. Date: May 4, 2006

(54) Portable survey inspection device

(76) Inventor: Robert McGinley, Skippack, PA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/980,882

(22) Filed: Nov. 3, 2004

(51) Int. Cl. H04B 1/38; H04M 1/00

(52) U.S. Cl. 455/90.3; 455/562.1

(57) ABSTRACT

A wireless inspection device comprising: telescoping boom for extending said device to a position to be tested; an access point affixed to an end of said boom means for outputting a wireless signal to be tested; a power pack for powering the access point; and a tripod on wheels affixed to the boom to move the device.

### FIELD OF THE INVENTION

The present invention is directed to a system and method for testing the strength of wireless signals. In particular, the present invention is directed to a system for testing the strength of signals and specific locations in a facility or location to be tested.

### BACKGROUND OF THE INVENTION

Wireless data telephony and the Internet has gained great popularity recently. Wireless is now being used extensively in businesses, industry, hospitals and schools to connect and network computers, voice and the like. Wireless systems require the use of an access point, which receives and transmits wireless signals from devices such as PCs. The proper placement of wireless access points is critical.

Wireless local area networks (WLANs) were originally intended to allow wireless connections to a wired local area network (LAN), such as where premises wiring systems were nonexistent or inadequate to support conventional wired LANs. The WLAN typically includes a mobile device including a network adapter (NA), a number of access points (APs) and a wired LAN. The APs may be radio base stations, each mounted in a separate fixed position and connected to the wired LAN. The NA communicates with the APs by formatted wireless communication signals to provide an interface between the computing device and the wired LAN. Because network adapters are now available in compact PC card form, WLANs are often used to service mobile computing devices, such as laptop computers and personal digital assistants (PDAs), thus providing mobile connectivity to data networks, such as the Internet or an intranet.

In designing a WLAN, care must be taken in locating the APs to ensure adequate radio coverage throughout the service area of the WLAN, while minimizing the costs associated with the installation of each AP. The APs must be configured to eliminate coverage gaps and to provide adequate coverage for areas of highly-concentrated wireless traffic. The APs, however, must not be placed so closely that proximate APs interfere with each other. Implementing a WLAN inside a building complicates the design because the layout and construction of the building affect the wireless signal transmissions between the NA and the AP.

For example, while wood, plaster, and glass are not serious barriers to the WLAN radio transmissions, brick and concrete walls can attenuate the signals beyond an acceptable threshold. In addition, the greatest obstacle to the wireless transmissions between the NAs and APs commonly found in all building environments is metal. For example, the metal used in desks, filing cabinets, reinforced concrete, and elevator shafts can significantly attenuate the signals transmitted between the NAs and the Aps, thus degrading network performance.

In addition, the communication schemes for transmitting signals between the NAs of the mobile devices and the APs are typically contention-oriented, such as those compliant with, for example, the IEEE 802.11 protocol, in order that all the mobile units in the environment may share the limited bandwidth resource. Such a contention-oriented protocol makes a signal interference between the APs is undesirable because if one AP can “hear” another, it will defer to the other just as it would defer to a mobile device transmitting within its coverage area. Thus, signal interference between APs degrades performance. Similarly, if a mobile device can be heard by more than on AP, all the APs in communication with the mobile device will defer.

Because radio propagation inside a building is frequently anomalous and seldom completely predictable, the design process for an indoor wireless installation is ordinarily iterative. After the initial design is complete, the APs may be temporarily installed at the locations specified in the initial design. The coverage areas of these points and the overlaps in the coverage area may be measured. Typically, coverage gaps and/or excessive overlaps are found. Based on the measured results, the AP locations may be adjusted as needed. Thereafter, more measurements may be taken and the installation reconfigured until an acceptable installation is found.

The step of adjusting the locations in order to re-test the configuration of the installation is expensive and time consuming. It commonly requires reconfiguring the locations of the AP and generating additional sets of signal strength measurements to determine whether coverage gaps and/or excessive overlaps exist. Accordingly, there exists a need for a manner in which to efficiently estimate coverage patterns in an indoor wireless installation.

There has been a long felt need for a versatile and all purpose testing device, which can be used to test the strength and position of APs. There has also been a long felt need for an inspection device which is portable, and which can be used to inspect a variety of locations, both indoor and outdoor.

It is therefore a principal object of the present invention to provide a system for enabling the position of access points to be quickly tested.

It is another object of the present invention to provide a system and method for quickly moving and testing the signal strength of access points for placement at a location or facility.

It is still a further object of the present invention to provide a system to easily move a portable boom with an access port around a facility to be tested.

These and other objects of the present invention will become apparent from the detailed description and claims which follow.

### SUMMARY OF THE INVENTION

In accordance with this long felt need, a testing device and method are disclosed. In a most preferred embodiment, the invention comprises boom means for extending to a position to be tested, and access points means affixed to an end of said boom means for permitting the wireless testing of said position to be tested.

In a second embodiment, the invention is directed to a testing device comprising boom means for extending to a site to be inspected, and an access points affixed to an end of said boom means for permitting testing of the strength of a signal at a point to be tested.

In another embodiment, the present invention comprises a telescoping boom for extending to a section to be tested and an access port for conveying a wireless signal and means for determining the strength of the signal. The testing device of the present invention, in a preferred embodiment, utilizes a powered access port to move about, which facilitates to test for the optimal signal position. This is accomplished by testing the signal using a portable device such as a PDA.

In still a further embodiment, the invention is a method for testing sections of an area to be tested comprising the following steps: extending a boom to a position to be inspected; attaching an access port on the end of the boom to emit and receive a wireless signal; and moving a portable wireless device relative to the boom and access ports to determine the signal strength at specified locations.

### BRIEF DESCRIPTION OF THE DRAWINGS

FIG. 1 a perspective view of the testing system of the present invention.

FIG. 2 is a perspective view of the hand-held inspection system of the present invention.

FIG. 3 is a perspective view of the testing system of the present invention in a collapsed state.

FIG. 4 is an alternative embodiment of the present invention affixed to the back of a vehicle.

FIGS. 5 and 6 are perspective views of the storage systems for the present invention.

FIGS. 7 and 8 are perspective views of the mounting brackets of the present invention.

FIG. 9 illustrates the operation of the present invention.

### DETAILED DESCRIPTION OF THE PRESENT INVENTION

The present invention is described with reference to the enclosed Figures wherein the same numbers are utilized where applicable. The present invention, in preferred embodiments, is directed to a device for permitting mobile testing of a wireless signal, such as emitted by devices as the Access Points 2230 by Nortel and comparable units made by Motorola, Linksys, Cisco, Alvarion, Symbol and the like. Wireless devices have gained great popularity in the business world and industry. The proper positioning of the wireless access points is critical to the proper operation of these systems.

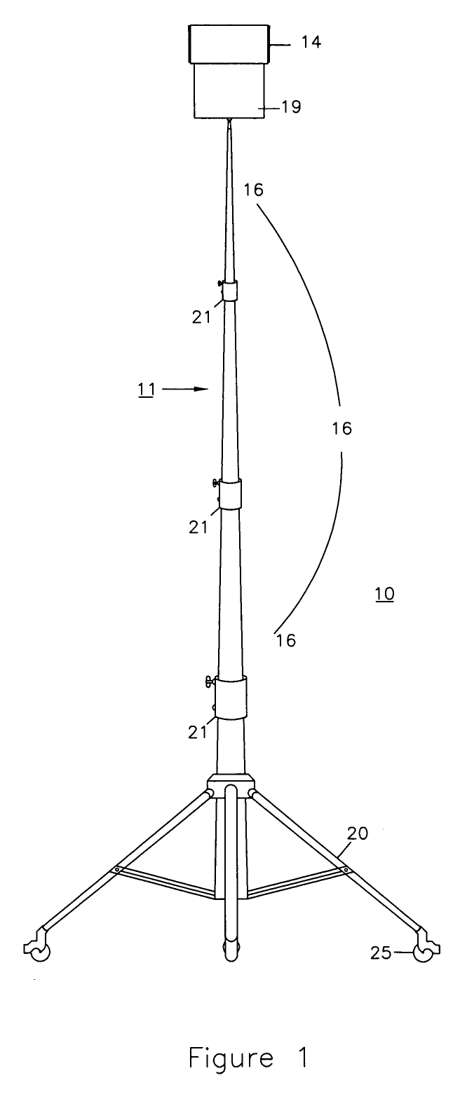

Referring to FIG. 1, the testing device 10 of the present invention, in a most preferred embodiment, comprises a boom 11 for extending an access port 14 to a position to be tested in a location or facility. A portable power pack 19 is included to power the device. The position to be tested is a position inside or outside a facility which will have or use a wireless network. The boom 12 is designed to be affixed to a wireless access point 14 affixed at a distal end of the boom 12.

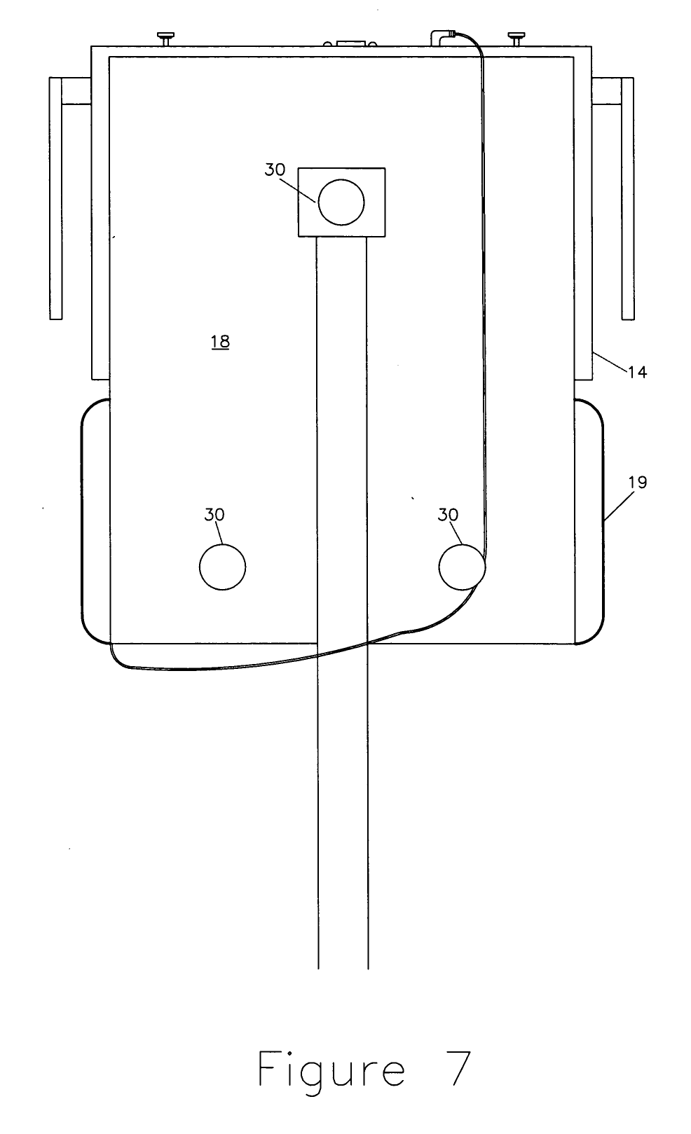

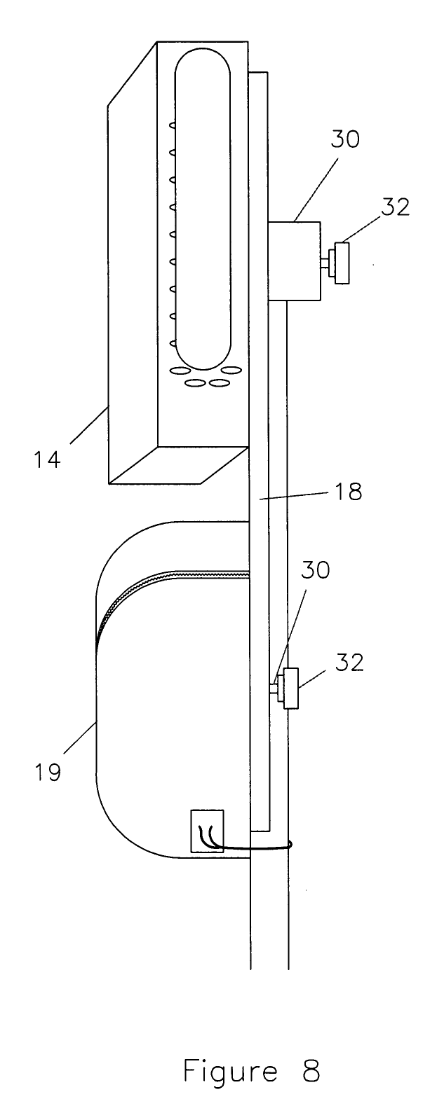

As shown in FIGS. 7 and 8, the system includes a mounting bracket 18 located on the boom which attaches the access point 14. The mounting bracket includes attachment mechanisms 30 and screws 32 to support the access port. The mounting bracket also supports the power pack 19.

In a preferred embodiment, the boom comprises a plurality of telescoping members 16 which can be adjusted manually and mechanically locked to a fixed length by means of a plurality of locking means or clamps 21. In this manner, the length of the boom means 16 can be selectively adjusted. The system further includes a self contained power pack 19 so that the system can be freely moved independently of a fixed power supply.

In a preferred embodiment, the boom 12 should comprise enough telescoping members 16 to facilitate the expansion of the device 10 a total length of about 40 feet. This length is sufficient to facilitate the full vertical examination of any internal or external area which needs to be tested for wireless capability.

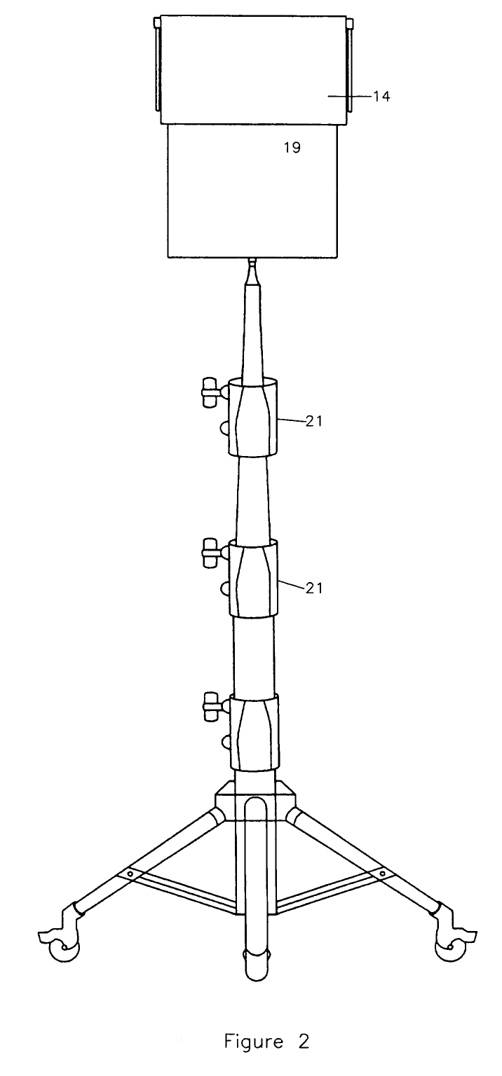

As shown in FIGS. 1 and 2, the device 10 of the present invention can be supported in a vertical position by means of a stand such as a tripod stand 20 with wheels or rollers 25. Stand 20 permits the device to be retained in a selected position while, for example, the operator takes a reading using a PDA or other portable device and then easily moves it to other areas to be tested.

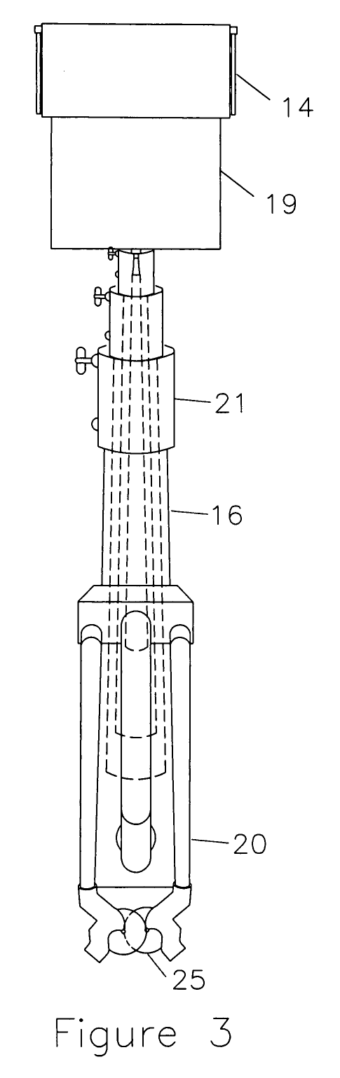

As noted above, the distal end of the boom has affixed thereto attached to a wireless access point 14 As shown in FIG. 3, the access point mechanism 14 comprises device such as the Nortel 2230. The access port mechanism is preferably powered by a portable power supply 19. The portable power supply 19 is similarly attached to the boom. The power supply may be fixed in an alternative embodiment.

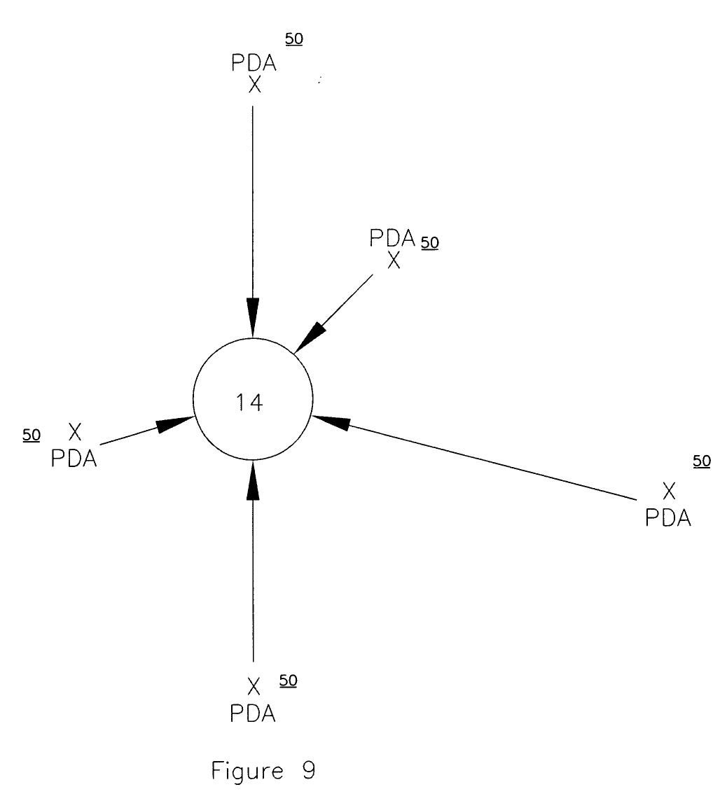

As shown in FIG. 9, a small receiver can be interfaced with the access port 14 and tested by the user of the device as he or she is testing the area.

Furthermore, the control box may include controls to extend the boom 12 and telescoping members to the desired length.

FIG. 3 illustrates the system in a collapsed position which illustrates the telescoping members 16 and wheels 25 collapsed.

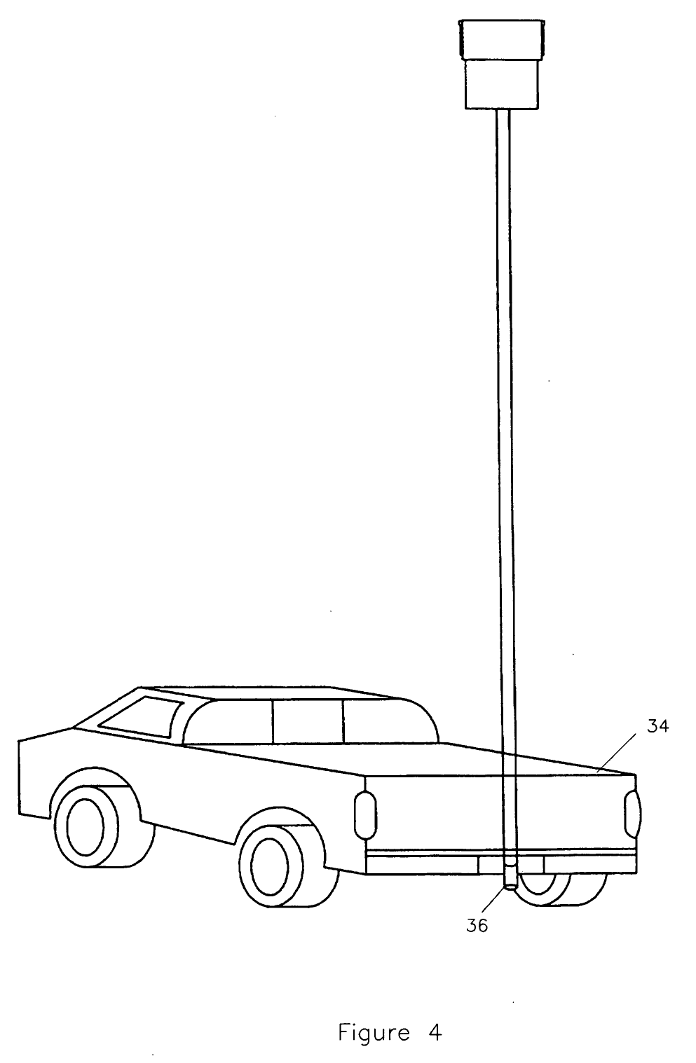

FIG. 4 illustrates a system which is designed to be placed on the tail of a vehicle 34. The bottom of the boom is affixed to a receiving cup 36 attached to the tail of the vehicle. The receiving cup 36 supports the telescoping member 12 as it is driven around an area to be tested. In this case, the access port may be located externally on a roof receiver, cell tower, light structure or roof. A wireless device such as a PDA located within the vehicle is then used to test signal strength at various points on the ground. These points correspond to work station areas where computers may be located.

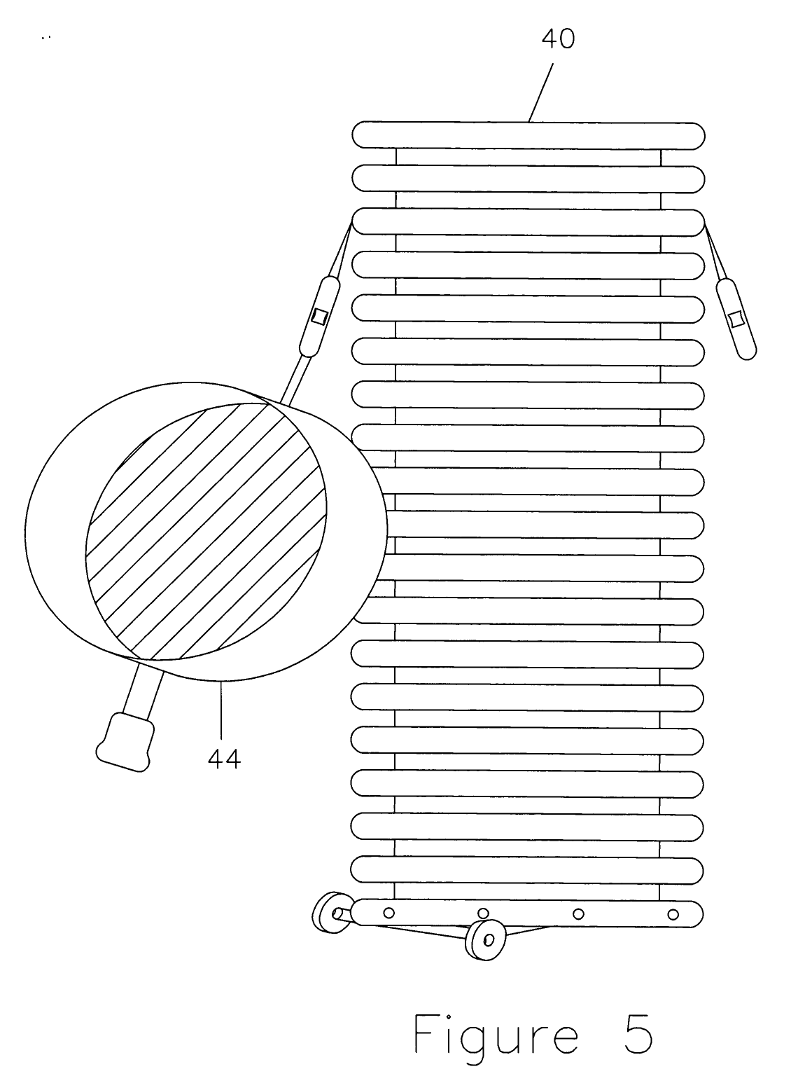

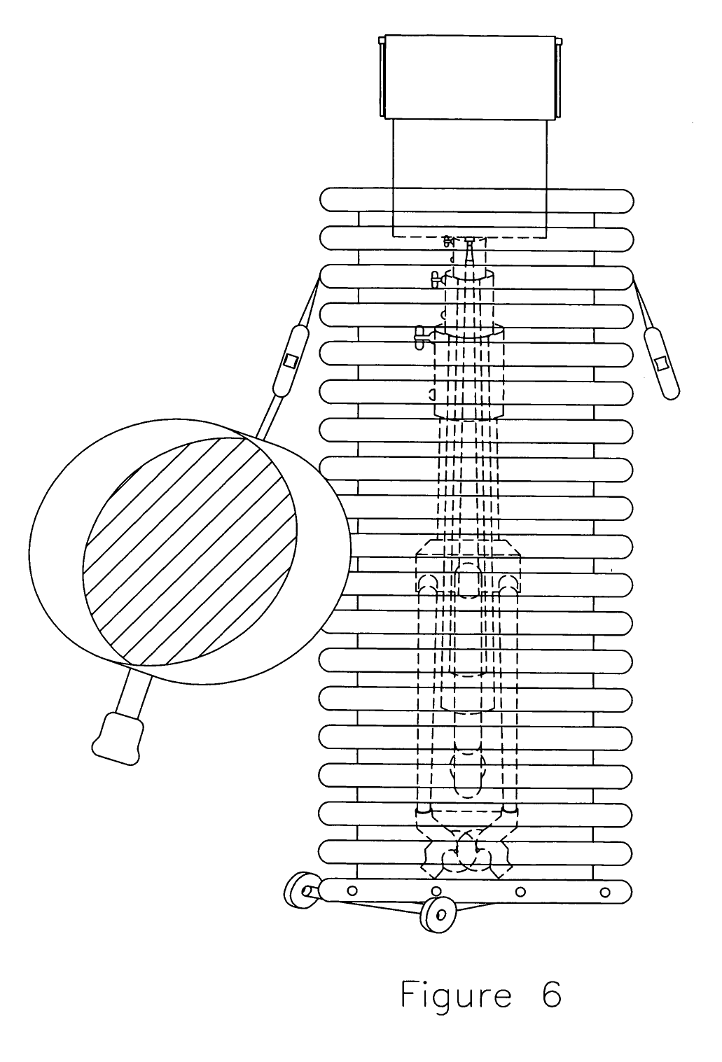

FIGS. 5 and 6 illustrate a storage mechanism for the transporting and storing the present invention. In one embodiment, the boom and tripod is designed to be folded and placed in a storage tube 40 with locking lid 44. The access point and power pack can thus be stored.

The operation of the present invention is described with reference to FIG. 9. The device 12 is moved around a location to be tested. The access port 14 is raised to a potential placement location in the boom. The access point is then powered up, using, for example, portable power supply 19. A portable wireless device 50 (e.g. PDA) is then used to test the signal of the access point at specific locations on the ground. By measuring signal strength at key locations, it can be determined if the access point 14 is properly placed for maximum effect.

The present invention has been described with reference to the enclosed Figures. It is to be appreciated that other embodiments fulfill the spirit and scope of the present invention is to be determined with reference to the claims appended hereto. The concept of this invention could be leased for access ports on cell towers.

1. A wireless testing device comprising:
telescoping boom for extending said device to a position to be tested;
an access point affixed to an end of said boom means for outputting a wireless signal to be tested.

2. The device of claim 1 further comprising a power pack to power the access point.

3. The device of claim 1 wherein said boom comprises a plurality of telescoping members.

4. The device of claim 1 further comprising a tripod on wheels to permit the device to be easily moved.

5. The mobile device of claim 1 further comprising a device for testing the signal strength of the access point

6. A wireless inspection device comprising:
telescoping boom for extending said device to a position to be tested;
an access port affixed to an end of said boom means for outputting a wireless signal to be tested; and
a power pack for powering the access point;
a tripod on wheels affixed to the boom to move the device.

7. A method for testing sections of an area to be tested:
extending a boom to a position to be inspected;
attaching an access point on the end of the boom to emit and receive a wireless signal;
moving a portable wireless device relative to the boom and access points to determine the signal strength at specified locations.
